(19) United States
(12) Patent Application Publication
(10) Pub. No.: US 2009/0117481 A1
(43) Pub. Date: May 7, 2009

(54) TONER FOR ONE-COMPONENT DEVELOPER

(76) Inventors: Hideaki YASUNAGA, Ibaraki-shi (JP); Yoshihiro Mikuriya, Nishinomiya-shi (JP); Masayuki Hagi, Minoo-shi (JP); Yoshitaka Sekiguchi, Nishinomiya-shi (JP); Hiroaki Katoh, Nagaokakyo-shi (JP); Kazuoki Fuwa, Kawanishi-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/241,656

(22) Filed: Sep. 30, 2008

(30) Foreign Application Priority Data
Nov. 1, 2007 (JP) 2007-284879

(51) Int. Cl. G03G 9/00; G03G 13/20; G03G 15/08

(52) U.S. Cl. 430/108.7; 430/109.4; 430/124.1; 399/252

(57) ABSTRACT

A toner for one-component developer, including a mother toner including a binder resin including a polyester resin as a main component, a colorant and a release agent; and an external additive in an amount of from 2.5 to 5.0 parts by weight per 100 parts by weight of the mother toner, wherein the toner includes a hexane-extracted volume of from 10 to 40 mg/g and has a cohesion of from 50 to 90%.

### BACKGROUND OF THE INVENTION

1. Field of the Invention

The present invention relates to a toner for one-component developer and a one-component image developer, and more particularly to a toner for one-component developer and a one-component image developer developing an electrostatic latent image with a thin toner layer formed on a developing roller by pressing a toner thereon with a regulation blade.

2. Discussion of the Background

Conventional electrophotographic image forming methods include charging the surface of an image bearer (photoreceptor), irradiating the surface thereof to form an electrostatic latent image thereon, developing the electrostatic latent image with a colored toner to form a toner image thereon, transferring the toner image onto a receiving material such as a transfer paper, and fixing the toner image thereon.

Dry developing methods used in electrophotographic image forming methods and electrostatic recording methods include a method of using a two-component developer including a toner and a carrier, and a method of using a one-component developer not including a carrier. The former stably produces good images, but is difficult to produce constant-quality images for long periods because the carrier is easy to deteriorate and a mixing ratio of the toner to the carrier (toner concentration) is easy to vary. In addition, image forming apparatuses using the two-component developer are difficult to maintain and downsize. Therefore, the latter method of using the one-component developer is drawing attention.

In the one-component developing method, a toner in a toner feed chamber is fed by a toner feed member and the toner fed thereby is pressed by a pressing member (regulation blade) to be charged and a layer thickness thereof is controlled. This method can be compact, but has fewer members than two-component developing methods, and is required to have higher performances than those thereof. Particularly, the toner needs to have such stable fluidity as to smoothly move from the toner feed chamber to the regulation member without a stirrer and such toughness as to endure pressure of the pressurizer.

On the other hand, various studies are made to increase releasability between fixing rollers and transfer papers with expansion of the developing area. Japanese published unexamined application No. 2004-138644 discloses, e.g., a one-component developer having a specified hexane-extracted volume and a DSC maximum peak, including toner particles (a mother toner) formed of a polyester compound (binder resin), paraffin wax (a release agent), colorant and a charge controlling agent; and a particulate silica (an external additive) added to the toner particles. Japanese published unexamined application No. 2005-49649 discloses a one-component developer including toner particles (a mother toner) formed of a binder resin, a colorant, a resin including a sulfur atom and a wax; an oil-treated particulate silica (an external additive) added to the toner particles, wherein the oil-treated particulate silica has a specified primary particle diameter and an oil-treated amount thereof. However, these one-component developers include a little of the external additives in an amount of 0.2 to 1.8 (1.2 in Example) parts by weight per 100 parts by weight of the mother toner. In addition, a cohesion thereof is not studied and such toughness, charge transport stability and solid image followability as the present inventors expect cannot be obtained. The charge transport stability is stability of a feed amount and a charge amount of the toner on the developing roller, and the unstable charge transport stability cannot stabilize the developability. The solid image followability is image density stability of solid images produced on papers.

Because of these reasons, a need exists for a toner for one-component developer having releasability when fixed, toughness and fluidity.

### SUMMARY OF THE INVENTION

Accordingly, an object of the present invention is to provide a toner for one-component developer having releasability when fixed, toughness and fluidity.

Another object of the present invention is to provide an image forming method using the toner for one-component developer.

A further object of the present invention is to provide an image forming apparatus using the toner for one-component developer.

Another object of the present invention is to provide a process cartridge using the toner for one-component developer.

These objects and other objects of the present invention, either individually or collectively, have been satisfied by the discovery of a toner for one-component developer, comprising:

a mother toner comprising a binder resin comprising a polyester resin as a main component, a colorant and a release agent; and

an external additive in an amount of from 2.5 to 5.0 parts by weight per 100 parts by weight of the mother toner,

wherein the toner comprises a hexane-extracted volume of from 10 to 40 mg/g and has a cohesion of from 50 to 90%.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating a longitudinal section of an image developer and a process cartridge forming a part of the image forming apparatus of the present invention; and

FIG. 2 is a schematic view illustrating a longitudinal section of another embodiment of an image developer forming a part of the image forming apparatus of the present invention.

### DETAILED DESCRIPTION OF THE INVENTION

The present invention provides a toner for one-component developer, a process cartridge, an image forming apparatus and an image forming method having good solid image followability and charge transport stability. More particularly, the present invention relates to a toner for one-component developer, comprising:

a mother toner comprising a binder resin comprising a polyester resin as a main component, a colorant and a release agent; and

an external additive in an amount of from 2.5 to 5.0 parts by weight per 100 parts by weight of the mother toner,

wherein the toner comprises a hexane-extracted volume of from 10 to 40 mg/g and has a cohesion of from 50 to 90%.

The binder resin is preferably a polyester resin preferably in terms of stress resistance in an image developer, and may be a hybrid resin including a polyester resin as a main component to increase dispersibility of a release agent (wax). The main component has a weight ratio not less than 50%. A combination of a polyester resin and a styrene-acrylic resin is preferably used in consideration of compatibility of with paraffin.

The polyester resin is typically formed by polycondensation between a polyol and a polycarboxylic acid. Specific examples of diols in the polyols include adducts of a bisphenol A such as polyoxypropylene(2,2)-2,2-bis(4-hydroxyphenyl)propane, polyoxypropylene(3,3)-2,2-bis(4-hydroxyphenyl)propane, polyoxypropylene(6)-2,2-bis(4-hydroxyphenyl)propane, polyoxyethylene(2,0)-2,2-bis(4-hydroxyphenyl)propane; ethylene glycol; diethylene glycol; triethylene glycol; 1,2-propylene glycol; 1,3-propylene glycol; 1,4-butadieneol; neo-pentyl glycol; 1,4-butenediol; 1,5-pentanediol; 1,6-hexanediol; 1,4-cyclohexanedimethanol; dipropyleneglycol; polyethyleneglycol; polytetramethyleneglycol; bisphenol A; hydrogenated bisphenol A; etc. Specific examples of tri- or more valent alcohols include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, 1,3,5-trihydroxybenzene, etc.

Specific examples of dicarboxylic acids in the polycarboxylic acids include a maleic acid, a fumaric acid, a citraconic acids, an itaconic acid, a glutaconic acid, a phthalic acid, an isophthalic acid, a terephthalic acid, a cyclohexane dicarboxylic acid, a succinic acid, an adipic acid, a sebacic acid, an azelaic acid, a malonic acid, a n-dodecenylsuccinic acid, an isododecenylsuccinic acid, a n-dodecylsuccinic acids, an isododecylsuccinic acid, a n-octenylsuccinic acid, an isooctenylsuccinic acid, a n-octylsuccinic acid, an isooctylsuccinic acid, their anhydrides or lower alkyl esters, etc.

Specific examples of tri- or more carboxylic acids include a 1,2,4-benzenetricarboxylic acid, a 2,5,7-naphthalenetricarboxylic acid, a 1,2,4-naphthalenetricarboxylic acid, a 1,2,4-butanetricarboxylic acid, a 1,2,5-hexanetricarboxylic acid, 1,3-dicarboxyl-2-methyl-methylenecarboxypropane, tetra(methylenecarboxyl)methane, a 1,2,7,8-octantetracarboxylic acid, an empol trimer acid, and their anhydrides and lower alkyl esters, etc.

In the present invention, a vinyl polyester resin is preferably used, which is prepared by a combination of a polycondensation reaction forming a polyester resin and a radical polymerization reaction forming a vinyl resin in a same container, using a mixture of a polyester resin material monomer, a vinyl resin material monomer and a monomer reacting with the both material monomers. The monomer reacting with the both material monomers is, i.e., a monomer usable in both of the polycondensation reaction and radical polymerization reaction. Namely, the monomer is a monomer having a polycondensation-reactable carboxyl group and a radical-polymerization-reactable vinyl group such as a fumaric acid, a maleic avid, an acrylic acid and a methacrylic acid.

The polyester resin material monomer includes the above-mentioned polyols and polycarboxylic acids. The vinyl material monomer includes styrenes or their derivatives such as styrene, o-methylstyrene, m-methylstyrene, p-methylstyrene, α-methylstyrene, p-ethylstyrene, 2,4-dimethylstyrene, p-tert-butylstyrene and p-chlorostyrene; ethylene unsaturated monoolefins such as ethylene, propylene, butylene and isobutylene; methacrylate alkyl esters such as methylmethacrylate, n-propylmethacrylate, isopropylmethacrylate, n-butylmethacrylate, isobutylmethacrylate, t-butylmethacrylate, n-pentylmethacrylate, isopentylmethacrylate, neopentylmethacrylate, 3-(methyl)butylmethacrylate, hexylmethacrylate, octylmethacrylate, nonylmethacrylate, decylmethacrylate, undecylmethacrylate and dodecylmethacrylate; acrylate alkyl esters such as methylacrylate, n-propylacrylate, isopropylacrylate, n-butylacrylate, isobutylacrylate, t-butylacrylate, n-pentylacrylate, isopentylacrylate, neopentylacrylate, 3-(methyl)butylacrylate, hexylacrylate, octylacrylate, nonylacrylate, decylacrylate, undecylacrylate and dodecylacrylate; unsaturated carboxylic acids such as an acrylic acid, a methacrylic acid, an itaconic acid and a maleic acid; acrylonitrile; maleate ester; itaconate ester; vinylchloride; vinylacetate; vinylbenzoate; vinylmethylethylketone; vinylhexylketone; vinylmethylether; vinylethylether; vinylisobutylether; etc. Specific examples of a polymerization initiator for polymerizing the vinyl resin material monomer include azo or diazo polymerization initiators such as 2,2′-azobis(2,4-dimethylvaleronitrile), 2,2′-isobutyronitrile, 1,1′-azobis(cyclohexane-1-carbonitrile) and 2,2′-azobis-4-methoxy-2,4-dimethylvaleronitrile; and peroxide polymerization initiators such as benzoylperoxide, dicumylperoxide, methylethylketoneperoxide, isopropylperoxycarbonate and lauroylperoxide.

The above-mentioned polyester resins are preferably used as a binder resin, and the following first and second binder resins are more preferably used in terms of improving the separativeness and offset resistance of the resultant oilless-fixing toner.

The first binder resin is a polyester resin prepared by polycondensating an adduct of bisphenol A with alkyleneoxide as the polyol, and a terephthalic acid and a fumaric acid as the polycarboxylic acid.

The second binder resin is a vinyl polyester resin prepared by using an adduct of bisphenol A with alkyleneoxide, a terephthalic acid, a trimellitic acid and a succinic acid as the polyester resin material monomer; styrene and butylacrylate as the vinyl resin material monomer; and a fumaric acid as the monomer reactive with both of the material monomers.

The first binder resin includes a hydrocarbon wax as mentioned above. In order to include a hydrocarbon wax in the first binder resin, the hydrocarbon wax is included in monomers forming the first binder resin when synthesized. For example, the hydrocarbon wax is included in an acid monomer and an alcohol monomer forming a polyester resin as the first binder resin, and the acid monomer and alcohol monomer are polycondensated. When the first binder resin is a vinyl polyester resin, the hydrocarbon wax is included in a polyester resin material monomer and a vinyl resin material monomer is dropped therein while stirred and heated to perform a polycondensation reaction and a radical polymerization reaction.

Typically, the lower the polarity of a wax, the better the releasability thereof from a fixing member (roller). The wax for use in the present invention is preferably a paraffin wax having no polarity.

The toner for one-component developer preferably includes a wax in an amount of from 2.5 to 7.0% by weight, and more preferably from 3.0 to 6.5% by weight. When less than 2.5% by weight, the releasability of the toner after fixed deteriorates, resulting in more windings of papers. When greater than 7.0% by weight, the wax interface chips the toner more, resulting in unstable particle diameter distribution.

In the present invention, the melting point of the wax is an endothermic peak thereof, which is measured with a differential scanning calorimeter when heated, and is preferably from 70 to 90° C. When higher than 90° C., the wax insufficiently melts in the fixing process and the resultant toner does not have sufficient separativeness. When lower than 70° C., the resultant toner has a problem of storage stability because the toner particles melt and are bonded with each other in an environment of high-temperature and humidity. The wax more preferably has a melting point of from 70 to 85° C., and furthermore preferably from 70 to 80° C. such that the resultant toner has sufficient separativeness.

The wax preferably has a half-value width of the endothermic peak not greater than 7° C., which is measured with a differential scanning calorimeter when heated. The wax in the present invention comparatively has a low melting point and a broad endothermic peak. Namely, a wax melting at a low temperature adversely affects the storage stability of the resultant toner.

Known colorants conventionally used in full color toners can be used in the toner of the present invention.

Specific examples of the colorant include carbon black, Aniline Blue, calcoil blue, chrome yellow, ultramarine blue, Dupont Oil Red, QUINOLINE YELLOW, Methylene blue-chloride, Copper Phthalocyanine, Malachite Green Oxalate, lamp black, Rose Bengal, C.I. Pigment Red 48:1, C.I. Pigment Red 122, C.I. Pigment Yellow 97, C.I. Pigment Yellow 12, C.I. Pigment Yellow 17, C.I. Pigment Yellow 74, C.I. Solvent Yellow 162, C.I. Pigment Yellow 180, C.I. Pigment Yellow 185, C.I. Pigment Blue 15:1, C.I. Pigment Blue 15:3, etc.

The toner preferably includes the colorant in an amount of from 2 to 15 parts by weight per 100 parts by weight of all the binder resin.

The colorant is preferably dispersed in a mixed binder resin of the first and second binder resins in the form of a masterbatch. The masterbatch preferably includes the colorant in an amount of from 20to 40% by weight.

Known charge controlling agents conventionally used in full color toners can be used.

Specific examples thereof include Nigrosine dyes, triphenylmethane dyes, chromium-containing metal complex dyes, molybdic acid chelate pigments, Rhodamine dyes, alkoxyamines, quaternary ammonium salts (including fluorine-modified quaternary ammonium salts), alkylamides, phosphor and its compounds, tungsten and its compounds, fluorine-containing activators, metal salts of salicylic acid, metal salts of salicylic acid derivatives, etc. Specific examples of marketed charge controlling agents include BONTRON P-51 (quaternary ammonium salt), BONTRONE-82 (metal complex of oxynaphthoic acid), BONTRON E-84 (metal complex of salicylic acid), and BONTRON E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and COPY CHARGE NX VP434 (quaternary ammonium salt), which are manufactured by Hoechst AG; LRA-901, and LR-147 (boron complex), which are manufactured by Japan Carlit Co., Ltd.; quinacridone, azo pigments, and polymers having a functional group such as a sulfonate group, a carboxyl group, a quaternary ammonium group, etc. Particularly, a charge controlling agent controlling a toner so as to have a negative polarity is preferably used.

The content of the charge controlling agent in the toner is determined depending on the variables such as choice of binder resin, presence of additives, and dispersion method. In general, the content of the charge controlling agent is preferably from 0.1 to 10 parts by weight, and more preferably from 1 to 5 parts by weight, per 100 parts by weight of the binder resin included in the toner. When the content is too low, a good charge property cannot be imparted to the toner. When the content is too high, the charge quantity of the toner excessively increases, and thereby the electrostatic attraction between the developing roller and the toner increases, resulting in deterioration of fluidity and decrease of image density.

It is preferable that silica is externally added to the toner of the present invention to assist the fluidity and developability thereof. The solid image followability and charge transport stability of the toner deteriorate without silica due to insufficient fluidity.

The silica preferably has an average diameter of from 30 to 120 nm, and more preferably from 30 to 70 nm. When less than 30 nm, the silica is likely to be buried in the toner, resulting in deterioration of solid image followability and charge transport stability thereof. When greater than 120 nm, the silica cannot be fixed on the mother toner, resulting in unstable fluidity of the toner.

In addition to silica, inorganic particulate materials typically and widely known as external additives can be added to the toner. Specific examples thereof include metal oxides such as aluminum oxide, titanium oxide, strontium titanate, cerium oxide, magnesium oxide, chrome oxide, tin oxide and zinc oxide; nitrides such as silicon nitride; carbonate such as silicon carbonate; metallic salts such as calcium sulfate, barium sulfate and calcium carbonate; fatty acid metallic salts such as zinc stearate and calcium stearate; and carbon black.

The toner preferably has a cohesion of from 50 to 90%, and more preferably from 50 to 70%. When less than 50%, the durability of the toner deteriorates when intermittently used and the fluidity thereof largely varies, resulting in deterioration of solid image followability. When greater than 90%, the influence of the mother toner becomes large and the fluidity thereof largely varies, resulting in deterioration of solid image followability.

The cohesion of a toner is measured by a powder tester from HOSOKAWA MICRON CORP. Sieves having openings of 20, 45 and 75 μm are placed in this order from the bottom, and 2.0 g of the toner is set on the sieve having an opening 75 μm. Amounts of the toner remaining on each of sieves having openings of 20, 45 and 75 μm are measured after oscillated at an amplitude of 1.0 mm for 10 sec and the cohesion is determined by the following formula:

Cohesion(%)=[(remaining amount on the sieve having an opening 75 μm)+0.5*(remaining amount on the sieve having an opening 45 μm+0.2*(remaining amount on the sieve having an opening 20 μm))*50.

The toner of the present invention preferably has a volume-average particle diameter of from 6 to 10 μm. When less than 6 μm, the cleanability of the toner deteriorates. When greater than 10 μm, the granularity of halftone images produced by the toner largely deteriorates.

The volume-average particle diameter of the toner can be measured by a Coulter counter TA-II or Coulter Multisizer II from Beckman Coulter, Inc. as follows:

0.1 to 5 ml of a detergent, preferably alkylbenzene sulfonate is included as a dispersant in 100 to 150 ml of the electrolyte ISOTON R-II from Coulter Scientific Japan, Ltd., which is a NaCl aqueous solution including an elemental sodium content of 1%;

2 to 20 mg of a toner sample is included in the electrolyte to be suspended therein, and the suspended toner is dispersed by an ultrasonic disperser for about 1 to 3 min to prepare a sample dispersion liquid; and

a volume and a number of the toner particles for each of the following channels are measured by the above-mentioned measurer using an aperture of 100 μm to determine a weight distribution and a number distribution:

2.00 to 2.52 μm; 2.52 to 3.17 μm; 3.17 to 4.00 μm; 4.00 to 5.04 μm; 5.04 to 6.35 μm; 6.35 to 8.00 μm; 8.00 to 10.08 μm; 10.08 to 12.70 μm; 12.70 to 16.00 μm; 16.00 to 20.20 μm; 20.20 to 25.40 μm; 25.40 to 32.00 μm; and 32.00 to 40.30 μm.

The external additive preferably has an adherence strength of from 50 to 70%, and more preferably from 50 to 65% to the mother toner. When less than 50%, free external additives increase, resulting in unstable fluidity of the toner. When greater than 70%, the external additives are likely to be buried in the toner, resulting in deterioration of solid image followability and charge transport stability thereof.

The adherence strength of the external additive is measured as follows. After 2 g of the toner was put in 30 ml of a surfactant solution including a surfactant of 10% by weight and the surfactant is fully applied to the toner, an energy was applied to the toner with an ultrasonic homogenizer at 40 W for 1 min to separate the toner. Then, the toner was washed and dried. The adherent amounts of an inorganic particulate material before and after the toner was subjected to the surfactant were measured with a fluorescence X-ray spectrometer. A wavelength-dispersive fluorescence X-ray spectrometer XRF1700 from Shimadzu Corp. was used to determine an individual element such as silicon of silica by a calibration method from toner pellets prepared by applying a force of 1N/cm² for 60 sec to 2 g of the toner before and after subjected to the surfactant.

The toner of the present invention preferably has a hexane-extracted volume of from 10 to 40 mg/g, and more preferably from 15 to 40 mg/g. When less than 10 mg/g, the elution of a wax deteriorates the releasability of the toner, resulting in windings of papers. When greater than 40 mg/g, the wax interface chips the toner more, resulting in unstable particle diameter distribution and deterioration of charge transportability due to decrease of charge sites.

The hexane-extracted volume is measured as follows:

placing 1.0 g of the toner into 10 ml of hexane having a temperature of 25° C. in a glass container for 10 min to form an extract;

volatilizing hexane from the extract to form a residue; and

measuring an amount of the residue.

The toner preferably includes the external additive in an amount of from 2.5 to 5.0 parts by weight, and more preferably from 3.0 to 4.5 parts by weight per 100 parts by weight of the mother toner. When less than 2.5 parts by weight, the external additives are buried more in the toner, and the durability thereof deteriorates and fluidity thereof largely varies, resulting in deterioration of solid image followability and charge transport stability thereof. When greater than 5.0 parts by weight, the coverage of the external additive increases and the wax seeps less, resulting in deterioration of the releasability of the toner.

The amount of the external additive is measured before the toner is subjected to the surfactant as mentioned above in the adherence strength thereof.

The toner of the present invention can be prepared by mixing the first binder resin including a hydrocarbon wax, the second binder resin and the colorant to prepare a mixture; kneading the mixture to prepare a kneaded mixture; cooling the kneaded mixture to prepare a hardened mixture; pulverizing the hardened mixture to prepare a pulverized mixture; classifying the pulverized mixture to prepare a colored particulate resin (mother toner) having a desired particle diameter; and mixing the colored particulate resin with an external additive.

The amount of external additive can be controlled with an amount thereof placed in a mixer mixing the mother toner and the external additive.

The hexane-extracted volume can be controlled by a mixer with an amount of the wax. Particularly, PCM from Ikegai Co., Ltd), EXTRUDER from Kurimoto, Ltd., and MIRACLE K.C.K from Asada Iron Works Co., Ltd. are preferably used. Among these kneaders, MIRACLE K.C.K from Asada Iron Works Co., Ltd. is more preferably used.

The cohesion can be controlled with an amount of the wax and the external additive. The cohesion lowers when the external additive increases, and rises when the wax increases. In addition, the cohesion lowers when the external additive has a small particle diameter.

The image forming method of the present invention includes at least electrostatic latent image forming process, a developing process, a transferring process and a fixing process, and preferably a cleaning process. Further, the image forming method optionally includes other processes such as a discharging process, a toner recycling process and a controlling process.

The image forming method of the present invention can be performed by the image forming apparatus mentioned later, including at least an electrostatic latent image bearer, an electrostatic latent image former, an image developer, a transferee and a fixer, and preferably a cleaner. Further, the image forming apparatus optionally includes other means such as a discharger, a recycler and a controller.

Specifically, the charging process, irradiating process, developing process, transferring process, discharging process and fixing process are performed with the charger, image developer, transferer, discharger and fixer, respectively. The other optional processes can be performed with the optional means mentioned above.

The electrostatic latent image forming process is a process of forming an electrostatic latent image on an electrostatic latent image bearer.

The material, shape, structure, size, etc. of the electrostatic latent image bearer (a photoreceptor) are not particularly limited, and can be selected from known electrostatic latent image bearers. However, the electrostatic latent image bearer preferably has the shape of a drum, and the material is preferably an inorganic material such as amorphous silicon and serene, and an organic material such as polysilane and phthalopolymethine.

The electrostatic latent image is formed by uniformly charging the surface of the electrostatic latent image bearer and irradiating imagewise light onto the surface thereof with the electrostatic latent image former.

The electrostatic latent image former includes at least a charger uniformly charging the surface of the electrostatic latent image bearer and an irradiator irradiating imagewise light onto the surface thereof.

The surface of the electrostatic latent image bearer is charged with the charger upon application of voltage.

The charger is not particularly limited, and can be selected in accordance with the purpose, such as an electroconductive or semiconductive rollers, bushes, films, known contact chargers with a rubber blade, and non-contact chargers using a corona discharge such as corotron and scorotron.

The surface of the electrostatic latent image bearer is irradiated with the imagewise light by the irradiator.

The irradiator is not particularly limited, and can be selected in accordance with the purpose, provided that the irradiator can irradiate the surface of the electrostatic latent image bearer with the imagewise light, such as reprographic optical irradiators, rod lens array irradiators, laser optical irradiators and a liquid crystal shutter optical irradiators.

In the present invention, a backside irradiation method irradiating the surface of the electrostatic latent image bearer through the backside thereof may be used.

The development process is a process of forming a visual image by developing the electrostatic latent image with the toner of the present invention.

The visual image can be formed by the image developer.

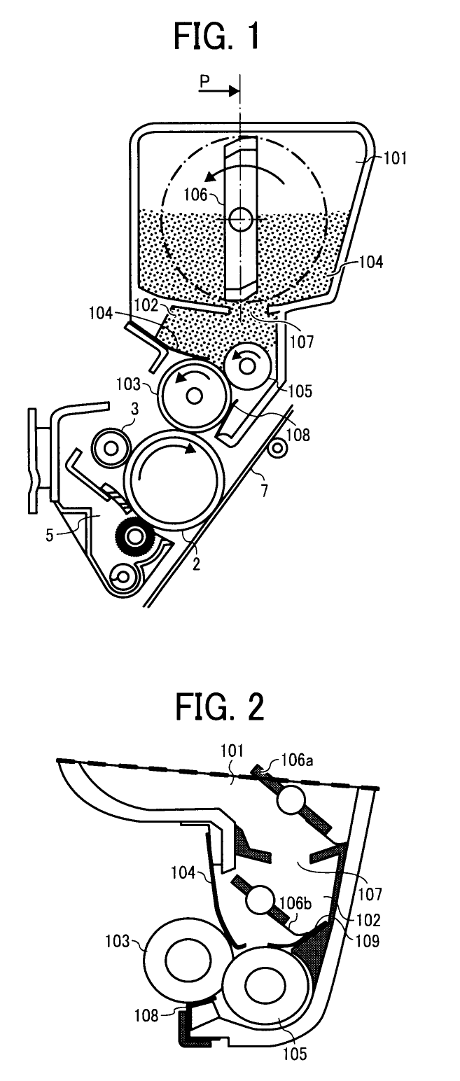

FIG. 1 is a schematic view illustrating a longitudinal section of (a first embodiment of) an image developer and a process cartridge forming a part of the image forming apparatus of the present invention.

The image developer includes a toner container (101) and a tone feeding chamber (102) below the toner container (101). A developing roller (103), and a layer regulator (104) and a feed roller (105) contacting the developing roller (103) are located below the tone feeding chamber (102).

Therefore, the process cartridge of the present invention includes at least an electrophotographic photoreceptor and an image developer using the toner of the present invention in a body, and is detachable from an image forming apparatus.

The developing roller (103) contacts the photoreceptor drum (2), a predetermined developing bias is applied to the developing roller (103) from a high-voltage power source (not shown). A toner agitator (106) located in the toner container (101) rotates in anticlockwise direction.

The toner stirring member (106) has a larger area at a part not passing near an opening (107) in the axial direction, and fully fluidizes and stirs a toner in the toner containing room (101). The toner stirring member (106) has a smaller area at a part passing near the opening (107) and prevents an excessive amount of the toner from leading thereto.

The toner near the opening (107) is adequately stirred by the toner stirring member, passes through the opening (107) and falls into the toner feed room (102) under its own weight. The surface of the feed roller (105) is coated with a foamed material having cells, efficiently absorbs the toner fallen into toner feed room (102) and prevents the toner from deteriorating due to concentration of pressure at a contact point with the developing roller (103). The foamed material has an electrical resistivity of from 10³ to 10¹⁴ Ω·cm.

The feed roller (105) is applied with a feed bias offset in the same direction of the charge polarity of the toner against the developing bias. The feed bias presses the preliminarily-charged toner toward the developing roller (103) at a contact point therewith. However, the offset direction is not limited thereto, the offset may be zero or the offset direction may be changed depending upon the toner.

The feed roller (105) rotates anticlockwise and feeds the toner adhering to the surface thereof to the surface of the developing roller (103) like coating. The developing roller (103) is coated with an elastic rubber layer and further coated with a surface layer formed of a material easily chargeable to have a polarity reverse to that of the toner. The elastic rubber layer has a hardness not greater than 50° when measured by JIS-A to prevent the toner from deteriorating due to concentration of pressure at a contact point with the layer regulation member (104). The elastic rubber layer has a surface roughness Ra of from 0.2 to 2.0 μm and holds a required amount of the toner at the surface thereof.

The developing roller (103) rotates anticlockwise and transfers the toner held at the surface thereof to the layer regulation member (104) and to a position facing the photoreceptor drum (2). The layer regulation member (104) is located at a position lower than the contact point between the feed roller (105) and the developing roller (103), and is a metallic plate spring material formed of SUS, phosphor bronze, etc. The layer regulation member (104) contacts its free end to the surface of the developing roller (103) at a pressure of from 10 to 100 N/m, and thins a layer of the toner and frictionally charges the toner.

Further, the layer regulation member (104) is applied with a regulation bias offset in the same direction of the charge polarity of the toner against the developing bias to assist when frictionally charging the toner. The photoreceptor drum (2) rotates clockwise, and therefore the surface of the developing roller (103) travels in the same direction of the traveling direction of the photoreceptor drum (2) at a position facing the photoreceptor drum (2). The thinned layer of the toner is transferred to the position facing the photoreceptor drum (2) and to the surface thereof to develop an electrostatic latent image according to the developing bias applied to the developing roller (103) and a latent image electric field formed by the electrostatic latent image. At a position where the toner remaining untransferred on the developing roller (103) returns into the toner feed room (102), a seal (108) is located contacting the developing roller (103) to prevent the toner form leaking out of the image developer.

The elastic rubbers on the surface of the developing roller (103) are not particularly limited and include, e.g., a styrene-butadiene copolymer rubber, an acrylonitrile-butadiene copolymer rubber, an acrylic rubber, an epichlorohydrin rubber, a urethane rubber, a silicon rubber, their mixtures, etc. Among these rubbers, a blend rubber including the epichlorohydrin rubber and the acrylonitrile-butadiene copolymer rubber is preferably used.

The developing roller for use in the present invention is produced by coating an elastic rubber on the outer circumference of an electroconductive shaft. The electroconductive shaft is formed of metals such as stainless.

FIG. 2 is a schematic view illustrating a longitudinal section of another embodiment of an image developer forming a part of the image forming apparatus of the present invention.

In this embodiment, atoner stirring member 106a is located in a toner container 101 and a toner stirring member 106b is located in a toner feed chamber 102, and an oscillator 109 is further formed thereon contacting a feed roller 105.

Except for the two toner stirring members 106 and the oscillator 109, the basic constitutions and operations are the same as those of the above-mentioned first embodiment.

The oscillator 109 is formed of a resin film and formed on the toner feed chamber 102 adjacent to the feed roller 105. The rotation of the feed roller 105 rotates oscillates the oscillator 109 to oscillate a toner in the toner feed chamber 102. The oscillation begins by the friction between the feed roller 105 and the resin film, and starts fluidizing the toner in the toner feed chamber 102.

The resin film is preferably formed of PET, polyimide, polypropylene, etc., and is more preferably formed of PET.

The resin film preferably has a thickness of from 0.07 to 0.13 mm, and more preferably from 0.09 to 0.11 mm. In addition, the resin film preferably has a free length of from 5.0 to 10.0 mm. When too short or long, the toner is not fully oscillated.

The oscillator 109 is curved in the opposite direction from that of curvature of the feed roller 105, but may be curved in the same direction from that of curvature of the feed roller 105.

The oscillator 109 applies a motion energy to the toner in the toner feed chamber 102 to more stabilize the fluidity thereof.

The transfer process is a process of transferring the visual image onto a recording medium, and the visual image is firstly transferred onto an intermediate transferer and secondly transferred onto a recording medium thereby, or directly transferred onto the recording medium. It is more preferable that two or more visual color images are firstly and sequentially transferred onto the intermediate transferer and the resultant complex full-color image is transferred onto the recording medium thereby.

The transferer preferably includes a first transferer transferring the two or more visual color images onto the intermediate transferer and a second transferee transferring the resultant complex full-color image on to the recording medium.

The intermediate transferer is not particularly limited, and can be selected from known transferers in accordance with the purpose, such as a transfer belt.

Each of the first and second transferers is preferably at least a transferer chargeable to separate the visible image from the electrostatic latent image bearer (photoreceptor) toward the recoding medium. The transferee may be one, or two or more.

The transferer includes a corona transferer using a corona discharge, a transfer belt, a transfer roller, a pressure transfer roller, an adhesive roller, etc.

The recording medium is not particularly limited, and can be selected from known recording media.

The visual image transferred onto the recording medium is fixed thereon by a fixer. Each color toner image or the resultant complex full-color image may be fixed thereon.

The fixer is not particularly limited, can be selected in accordance with the purpose, and known heating and pressurizing means are preferably used. The heating and pressurizing means include a combination of a heating roller and a pressure roller, and a combination of a heating roller, a pressure roller and an endless belt, etc.

The heating temperature is preferably from 80 to 200° C.

In the present invention, a known optical fixer may be used with or instead of the fixer in accordance with the purpose.

The electrostatic latent image bearer is discharged by the discharger upon application of discharge bias.

The discharger is not particularly limited, and can be selected from known dischargers, provide that the discharger can apply the discharge bias to the electrostatic latent image bearer, such as a discharge lamp.

The toner remaining on the electrostatic latent image bearer is preferably removed by the cleaner.

The cleaner is not particularly limited, and can be selected from known cleaners, provide that the cleaner can remove the toner remaining thereon, such as a magnetic brush cleaner, an electrostatic brush cleaner, a magnetic roller cleaner, a blade cleaner, a brush cleaner and a web cleaner.

The toner removed by the cleaner is recycled into the image developer with a recycler.

The recycler is not particularly limited, and known transporters can be used.

The controller is not particularly limited, and can be selected in accordance with the purpose, provided the controller can control the above-mentioned means, such as a sequencer and a computer.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Examples 1 to 8 and Comparative Examples 1 to 12

### [Preparation of the First Binder Resin]

600 g of styrene, 110 g of butylacrylate, 30 g of acrylic acid as vinyl monomers and 30 g of dicumylperoxide as a polymerization initiator were placed in a dripping funnel to prepare a mixed liquid. 1,230 g of polyoxypropylene(2,2) -2,2-bis(4-hydroxyphenyl)propane, 290 g of polyoxyethylene(2,2)-2,2-bis(4-hydroxyphenyl)propane, 250 g of isododecenylsuccinicanhydride, 310 g of terephthalic acid and 180 g of 1,2,4-benznetricarbonateanhydride as polyol; and 7 g of dibutyltinoxide as an esterification catalyst were mixed to prepare a polyester monomer. 4 parts by weight of paraffin wax having a melting point of 73.3° C. and a half-value width of the endothermic peak of 4° C. when measured with a differential scanning calorimeter and 100 parts by weight of the polyester monomer were placed in a 5-litter four-neck flask having a thermometer, a stainless stirrer, a failing condenser and a nitrogen inlet tube to prepare a mixture. The mixed liquid including the vinyl monomers and polymerization initiator was dropped for 1 hr in flask under a nitrogen atmosphere in a mantle heater at 160° C. while the mixture therein was stirred. After an addition polymerization was continued for 2 hrs at 160° C., a condensation polymerization was performed at 230° C. The polymerization degree was traced by a softening point measured with a constant-load extrusion capillary rheometer, and the reaction was finished when the resultant resin H1 had a desired softening point of 130° C.

### [Preparation of the Second Binder Resin]

2,210 g of polyoxypropylene(2,2)-2,2-bis(4-hydroxyphenyl)propane, 850 g of terephthalic acid and 120 g of 1,2,4-benznetricarbonateanhydride as polyol; and 0.5 g of dibutyltinoxide as an esterification catalyst were placed in a 5-litter four-neck flask having a thermometer, a stainless stirrer, a falling condenser and a nitrogen inlet tube and subjected to a condensation polymerization under a nitrogen atmosphere in a mantle heater at 230° C. The polymerization degree was traced by a softening point measured with a constant-load extrusion capillary rheometer, and the reaction was finished when the resultant resin L1 had a desired softening point of 115° C.

### [Preparation of Toner Particles]

After a masterbatch containing 100 parts by weight of a binder resin including 111 by ratio of the first binder resin and 100 by ratio of the second binder resin, 1.75 parts of a charge controlling agent LR-147 from Nippon Carlit Co., Ltd. and 4 parts by weight of a colorant C.I. Pigment Red 57-1 as a charge controlling agent (CCA) were fully mixed in a HENSCHEL MIXER to prepare a mixture, the mixture was melted and kneaded in a monoaxial extruder KCK42 fron Asada Iron Works Co., Ltd. at 100° C. and 70 kg/h to prepare a kneaded mixture. After the kneaded mixture was extended upon application of pressure with a cooling press roller to have a thickness of 2 mm and cooled with a cooling belt to prepare a hardened mixture, the hardened mixture was crushed with a feather mill to prepare a crushed mixture. Then, the crushed mixture was pulverized with a mechanical pulverizer KTM from Kawasaki Heavy Industries, Ltd. to have a volume-average particle diameter of from 10 to 12 μm and further pulverized with a jet pulverizer IDS from Nippon Pneumatic Mfg. Co., Ltd. to prepare a pulverized mixture. The pulverized mixture was classified with a rotor classifier 100ATP from Hosokawa Micron Group to prepare a colored particulate resin 1. The colored particulate resin 1 had a particle diameter of 8.0 μm. The procedure for preparation of the colored particulate resin 1 was repeated to prepare colored particulate resins 2 to 10 except for changing the contents of the first and second binder resins as shown in Table 1-1.

An inorganic particulate material was added to 100 parts of each of the colored particulate resins 1 to 10 in a desired amount, and the mixture was mixed in HENSCHEL MIXER to prepare magenta toner particles 1 to 10. The names and contents of the inorganic particulate materials are shown in Table 1-2. The compositions, external additives and properties of the magenta toner particles 1 to 10, and the results of the image quality evaluations produced therewith are shown in Tables 1-1 to 1-4.

TABLE 1-1

| | | Composition | | |
|---|---|---|---|---|
| | | 1^{st} binder | 2^{nd} binder | Wax qty. |
| Example 1 | Toner 1 | 100 | 111 | 6.7 |
| Example 2 | Toner 2 | 100 | 150 | 5.7 |
| Example 3 | Toner 3 | 100 | 200 | 4.7 |
| Example 4 | Toner 4 | 100 | 300 | 3.5 |
| Example 5 | Toner 5 | 100 | 380 | 3.0 |
| Example 6 | Toner 1 | 100 | 111 | 6.7 |
| Example 7 | Toner 1 | 100 | 111 | 6.7 |
| Example 8 | Toner 1 | 100 | 111 | 6.7 |
| Comparative | Toner 6 | 100 | 100 | 7.1 |
| Example 1 | | | | |
| Comparative | Toner 7 | 100 | 50 | 9.4 |
| Example 2 | | | | |
| Comparative | Toner 8 | 100 | 900 | 1.4 |
| Example 3 | | | | |
| Comparative | Toner 9 | 100 | 25 | 11.3 |
| Example 4 | | | | |
| Comparative | Toner 10 | 100 | 0 | 14.2 |
| Example 5 | | | | |
| Comparative | Toner 1 | 100 | 111 | 6.7 |
| Example 6 | | | | |
| Comparative | Toner 1 | 100 | 111 | 6.7 |
| Example 7 | | | | |
| Comparative | Toner 1 | 100 | 111 | 6.7 |
| Example 8 | | | | |
| Comparative | Toner 1 | 100 | 111 | 6.7 |
| Example 9 | | | | |
| Comparative | Toner 1 | 100 | 111 | 6.7 |
| Example 10 | | | | |
| Comparative | Toner 1 | 100 | 111 | 6.7 |
| Example 11 | | | | |
| Comparative | Toner 1 | 100 | 111 | 6.7 |
| Example 12 | | | | |

TABLE 1-2

| | | External Additive | | | |
|---|---|---|---|---|---|
| | | Name | Qty. | Name | Qty. |
| Example 1 | Toner 1 | R972 | 1.0 | RX50 | 2.5 |
| Example 2 | Toner 2 | R972 | 1.0 | RX50 | 2.5 |
| Example 3 | Toner 3 | R972 | 1.0 | RX50 | 2.5 |
| Example 4 | Toner 4 | R972 | 1.0 | RX50 | 2.5 |
| Example 5 | Toner 5 | R972 | 1.0 | RX50 | 2.5 |
| Example 6 | Toner 1 | R972 | 1.0 | RX50 | 3.5 |
| Example 7 | Toner 1 | R972 | 1.0 | RX50 | 1.5 |
| Example 8 | Toner 1 | R972 | 1.0 | RX50 | 2.5 |
| Comparative | Toner 6 | R972 | 1.0 | RX50 | 2.5 |
| Example 1 | | | | | |
| Comparative | Toner 7 | R972 | 1.0 | RX50 | 2.5 |
| Example 2 | | | | | |
| Comparative | Toner 8 | R972 | 1.0 | RX50 | 2.5 |
| Example 3 | | | | | |
| Comparative | Toner 9 | R972 | 1.0 | RX50 | 2.5 |
| Example 4 | | | | | |
| Comparative | Toner 10 | R972 | 1.0 | RX50 | 2.5 |
| Example 5 | | | | | |
| Comparative | Toner 1 | R972 | 0.8 | RX50 | 1.5 |
| Example 6 | | | | | |
| Comparative | Toner 1 | R972 | 0.6 | RX50 | 1.5 |
| Example 7 | | | | | |
| Comparative | Toner 1 | R972 | 2.0 | RX50 | 3.5 |
| Example 8 | | | | | |
| Comparative | Toner 1 | STT30S | 1.0 | RX50 | 2.0 |
| Example 9 | | | | | |
| Comparative | Toner 1 | R972 | 1.5 | TG811F | 1.0 |
| Example 10 | | | | | |
| Comparative | Toner 1 | R972 | 1.0 | RX50 | 2.5 |
| Example 11 | | | | | |
| Comparative | Toner 1 | R972 | 1.0 | RX50 | 2.5 |
| Example 12 | | | | | |

Volume-average particle diameter

| | | |
|---|---|---|
| RX50 | 40 nm | NipponAerosil Co., Ltd. |
| RX972 | 18 nm | NipponAerosil Co., Ltd. |
| TG811F | 8 nm | CAB-O-SIL |
| STT30S | 15 nm | Titan Kogyo, Ltd. |

TABLE 1-3

| | | Toner Properties | | |
|---|---|---|---|---|
| | | | Hexamine-extracted | Adherence |
| | | Cohesion | volume | strength |
| Example 1 | Toner 1 | 64 | 36 | 63 |
| Example 2 | Toner 2 | 60 | 31 | 61 |
| Example 3 | Toner 3 | 55 | 24 | 57 |
| Example 4 | Toner 4 | 52 | 19 | 53 |
| Example 5 | Toner 5 | 50 | 17 | 51 |
| Example 6 | Toner 1 | 50 | 36 | 50 |
| Example 7 | Toner 1 | 69 | 36 | 66 |
| Example 8 | Toner 1 | 64 | 36 | 63 |
| Comparative | Toner 6 | 73 | 51 | 65 |
| Example 1 | | | | |
| Comparative | Toner 7 | 85 | 51 | 69 |
| Example 2 | | | | |
| Comparative | Toner 8 | 48 | 12 | 43 |
| Example 3 | | | | |
| Comparative | Toner 9 | 86 | 51 | 75 |
| Example 4 | | | | |
| Comparative | Toner 10 | 91 | 56 | 80 |
| Example 5 | | | | |
| Comparative | Toner 1 | 66 | 36 | 66 |
| Example 6 | | | | |
| Comparative | Toner 1 | 70 | 36 | 71 |
| Example 7 | | | | |
| Comparative | Toner 1 | 46 | 36 | 48 |
| Example 8 | | | | |
| Comparative | Toner 1 | 95 | 36 | 32 |
| Example 9 | | | | |
| Comparative | Toner 1 | 19 | 36 | 59 |
| Example 10 | | | | |
| Comparative | Toner 1 | 29 | 36 | 39 |
| Example 11 | | | | |
| Comparative | Toner 1 | 92 | 36 | 73 |
| Example 12 | | | | |

TABLE 1-4

| | Image Evaluation | | | |
|---|---|---|---|---|
| | | Charge | | Particle |
| | Solid image | transport | | diameter |
| | followability | stability | Separativeness | distribution |
| Example 1 | ◯ | ◯ | ◯ | ◯ |
| Example 2 | ◯ | ◯ | ◯ | ◯ |
| Example 3 | ◯ | ◯ | ◯ | ◯ |
| Example 4 | ◯ | ◯ | ◯ | ◯ |
| Example 5 | ◯ | ◯ | ◯ | ◯ |
| Example 6 | ◯ | ◯ | ◯ | ◯ |
| Example 7 | ◯ | ◯ | ◯ | ◯ |
| Example 8 | ⊚ | ⊚ | ◯ | ◯ |
| Comparative | ◯ | X | ◯ | X |
| Example 1 | | | | |
| Comparative | ◯ | X | ◯ | X |
| Example 2 | | | | |
| Comparative | X | ◯ | X | ◯ |
| Example 3 | | | | |
| Comparative | X | X | ◯ | X |
| Example 4 | | | | |
| Comparative | X | X | ◯ | X |
| Example 5 | | | | |
| Comparative | X | X | ◯ | ◯ |
| Example 6 | | | | |
| Comparative | X | X | ◯ | ◯ |
| Example 7 | | | | |
| Comparative | X | X | X | ◯ |
| Example 8 | | | | |
| Comparative | X | X | ◯ | ◯ |
| Example 9 | | | | |
| Comparative | X | X | ◯ | ◯ |
| Example 10 | | | | |
| Comparative | X | X | ◯ | ◯ |
| Example 11 | | | | |
| Comparative | X | X | ◯ | ◯ |
| Example 12 | | | | |

### [Image Evaluation]

Image evaluations were performed by a color laser printer IPSIO CX2500 from Ricoh Company, Ltd. Two image developers each having an oscillator a polyester film was attached and not attached to were used.

### Solid Image Followability

Two solid images were produced. The differences of image density of the top end of the first image and the bottom end of the second image were visually observed.

⊚ very good

◯ good

× NG

### Charge Transport Stability

5,000 images (1 piece/job) having image density of 1% were produced to evaluate the charge transport stability.

⊚ very good

◯ good

× NG

### Separativeness

Paper windings at the fixer when solid images were produced were observed.

⊚ very good

◯ no windings

× winded and jammed

### Particle Diameter Distribution

5,000 images (1 piece/job) having image density of 1% were produced to evaluate stability of the particle diameter distribution.

⊚ very good

◯ good

× NG

This application claims priority and contains subject matter related to Japanese Patent Application No. 2007-284879 filed on Nov. 1, 2007, the entire contents of which are hereby incorporated by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner for one-component developer, comprising:
a mother toner comprising a binder resin comprising a polyester resin as a main component, a colorant and a release agent; and
an external additive in an amount of from 2.5 to 5.0 parts by weight per 100 parts by weight of the mother toner,
wherein the toner comprises a hexane-extracted volume of from 10 to 40 mg/g and has a cohesion of from 50 to 90%.

2. The toner for one-component developer of claim 1, wherein the external additive is silica.

3. The toner for one-component developer of claim 2, wherein the silica has an average particle diameter of form 30 to 120 nm.

4. The toner for one-component developer of claim 1, wherein the external additive has an adherence strength of from 50 to 70% to the mother toner.

5. The toner for one-component developer of claim 1, wherein the toner has a volume-average particle diameter of from 6 to 10 μm.

6. An image forming method, comprising:
charging an image bearer;
irradiating the image bearer to form an electrostatic latent image thereon;
developing the electrostatic latent image with the toner according to claim 1 to form a toner image on the image bearer;
transferring the toner image onto a transfer paper; and
fixing the toner image on the transfer paper.

7. An image forming apparatus, comprising:
an image bearer;
a charger configured to charge the image bearer;
an irradiator configured to irradiate the image bearer to form an electrostatic latent image thereon;
an image developer configured to develop the electrostatic latent image with the toner according to claim 1 to form a toner image on the image bearer;
a transferer configured to transfer the toner image onto a transfer paper; and
a fixer configured to fix the toner image on the transfer paper.

8. A process cartridge, comprising:
an image bearer configured to bear an electrostatic latent image;
an image developer configured to develop the electrostatic latent image with the toner according to claim 1 to form a toner image on the image bearer; and
at least a charger, a cleaner or a combination thereof.

9. The image forming apparatus of claim 7, wherein the image developer comprises:
a developing roller configured to visualize the electrostatic latent image;
a feed roller configured to feed the toner for one-component developer to the developing roller; and
a tone feeding chamber adjacent to the developing roller and the feed roller, comprising an oscillator.

10. The image forming apparatus of claim 9, wherein the oscillator is a resin film comprising a fixed end and a free end contacting the feed roller.
